(19) United States
(12) Patent Application Publication
(10) Pub. No.: US 2019/0143625 A1
(43) Pub. Date: May 16, 2019

(54) AUTOMATIC HEAT-INSULATING MATERIAL REPLACEMENT DEVICE

(71) Applicant: Chi-Wah LAU, Hong Kong (HK)

(72) Inventor: Chi-Wah LAU, Hong Kong (HK)

(21) Appl. No.: 15/890,560

(22) Filed: Feb. 7, 2018

(30) Foreign Application Priority Data
Nov. 15, 2017 (TW) 106139519

(51) Int. Cl. B31B 50/00; B31D 5/00; B31B 50/74

(52) U.S. Cl. CPC B31B 50/006; B31B 2120/40; B31B 50/747; B31D 5/00

(57) ABSTRACT

An automatic heat-insulating material replacement device includes a heat-insulating material replacement rack and a cutter. The replacement rack is rotatably connected to a supporting frame and is pivotally provided with a first and a second reel, which are wound with a first and a second heat-insulating material respectively. The first heat-insulating material has one end to be transported and coated to a substrate. When the first heat-insulating material is almost used up, the replacement rack is rotated to bond the second heat-insulating material to the first heat-insulating material adhesively, allowing the latter to be driven by the former and to be coated to the corresponding substrate. The cutter severs the first heat-insulating material at a position between the opposite end of the first heat-insulating material and the adhesively bonded area of the two heat-insulating materials so that the remaining first heat-insulating material on the first reel can be replaced.

### FIELD OF THE INVENTION

The present invention relates to a device for replacing a heat-insulating material. More particularly, the invention relates to an automatic heat-insulating material replacement device that is used in a heat-insulating cardboard manufacturing system and that, when a first heat-insulating material is left with a predetermined amount during use, can rapidly connect a second heat-insulating material to the first heat-insulating material and cut off the remaining first heat-insulating material so that an operator can remove the remaining first heat-insulating material and replace it with a new heat-insulating material.

### BACKGROUND OF THE INVENTION

When seafood products are no longer fresh, they have much lower nutritional value and may even become poisonous and hence harmful to consumers' health. It is therefore imperative to maintain the freshness of seafood products during long-distance transportation and storage.

Nowadays, seafood, especially live aquatic animals, are generally preserved and transported in the following ways:

(1) The water in which live aquatic animals (e.g., fish or shrimps) are kept is cooled down to a temperature that suspends the animals' vital activities. The inactive aquatic animals are then boxed without water for transportation. Once the destination is reached, the boxed aquatic animals are reinvigorated by putting them back into water.

(2) Dry ice, a breathable material (e.g., hay, cloth, or sponge), and live aquatic animals are sequentially placed into a box, one layer after another, in order for the aquatic animals to hibernate as a result of low temperature.

(3) Live aquatic animals and ice are put into a box where sea water and fresh water are mixed at a predetermined ratio, the goal being to keep the animals in a low-temperature state.

(4) Boxed aquatic animals are sprayed with sea water on a regular basis during transportation. In summer, ice may be put into the box to lower the temperature in the box.

It can be known from the above that the existing seafood/live aquatic animal transportation methods place great emphasis on temperature. “Low temperature” in particular is a major factor in keeping seafood products fresh, and this explains why cardboard boxes that provide good heat insulation can effectively preserve the freshness of seafood products during long-distance transportation. Cardboard boxes dedicated to the transportation of seafood are typically manufactured by first coating cardboard with a heat-insulating material (thus forming heat-insulating cardboard) so that the resulting cardboard boxes are capable of heat insulation, meaning the temperature outside such a box will not easily affect the temperature inside the box.

Nevertheless, the applicant of the present patent application has found that the “replacement of heat-insulating material” in a conventional heat-insulating cardboard manufacturing system still leaves room for improvement. More specifically, a conventional heat-insulating cardboard manufacturing system at least includes a cardboard conveying mechanism and a heat-insulating material bonding mechanism. The cardboard conveying mechanism is configured to transport plural pieces of cardboard sequentially into the heat-insulating material bonding mechanism, which coats each piece of cardboard with a heat-insulating material and bonds the latter adhesively to the former. Once the heat-insulating material is used up, an operator must bring the entire heat-insulating cardboard manufacturing system to a halt in order to replace what is left of the heat-insulating material with a new heat-insulating material. During the replacing process, the operator has to detach and reinstall all the related parts, leading to a downtime of 10˜20 minutes, which lowers the manufacturing efficiency of heat-insulating cardboard seriously. The issue to be addressed by the present invention is to provide an effective improvement over the existing heat-insulating material replacement method so as to raise the manufacturing efficiency of heat-insulating cardboard.

### BRIEF SUMMARY OF THE INVENTION

In view of the deficiencies in use of the conventional heat-insulating cardboard manufacturing systems, the inventor of the present invention conducted extensive research and repeated tests based on years of practical experience in research and development in the industry and finally succeeded in developing an automatic heat-insulating material replacement device that features ease of implementation and operation.

One objective of the present invention is to provide an automatic heat-insulating material replacement device for use in a heat-insulating cardboard manufacturing system. The heat-insulating cardboard manufacturing system at least includes a substrate conveying mechanism, a heat-insulating material bonding mechanism, and the heat-insulating material replacement device. The substrate conveying mechanism can transfer a substrate into the heat-insulating material bonding mechanism so that the substrate is coated with a heat-insulating material on one side. The present invention is characterized in that the heat-insulating material replacement device includes a base, a supporting frame, a heat-insulating material replacement rack, and a vertical stand. The supporting frame has a bottom portion mounted on the base and is provided with the heat-insulating material replacement rack. The heat-insulating material replacement rack has a middle section pivotally connected to the supporting frame and can therefore rotate about an axis defined by the supporting frame. The heat-insulating material replacement rack has two ends pivotally provided with a first reel and a second reel respectively. A first heat-insulating material is connected to the first reel at one end (hereinafter referred to as the first end of the first heat-insulating material) and is wound around the first reel. The opposite end of the first heat-insulating material is transported to the heat-insulating material bonding mechanism in order to coat the substrate with the first heat-insulating material. A second heat-insulating material is connected to the second reel at one end, is wound around the second reel, and is provided with an adhesive layer on an outer surface portion adjacent to the opposite end (hereinafter referred to as the second end of the second heat-insulating material). The vertical stand is provided with a cutter adjacent to the first reel. The present invention is further characterized in that, when the first heat-insulating material is left with a predetermined amount during use, the heat-insulating material replacement rack can be rotated in a first direction so that each of the first reel and the second reel is displaced to a position adjacent to the original position of the other. As a result, the adhesive layer of the second heat-insulating material is adhesively bonded to the surface of the first heat-insulating material, allowing the second end of the second heat-insulating material to be transferred to the heat-insulating material bonding mechanism along with the first heat-insulating material, and hence the substrate to be coated with the second heat-insulating material. Also, the cutter is displaced toward the first heat-insulating material and severs the first heat-insulating material at a position between the first end of the first heat-insulating material and the area where the two heat-insulating materials are adhesively bonded together, making it possible for an operator to remove the remaining portion of the first heat-insulating material and put a new heat-insulating material on the first reel while the second heat-insulating material is being transferred to the heat-insulating material bonding mechanism, thereby shortening the downtime of the heat-insulating cardboard manufacturing system.

### BRIEF DESCRIPTION OF THE SEVERAL VIEWS OF THE DRAWINGS

The objective, technical features, and effects of the present invention can be better understood by referring to the following detailed description of an illustrative embodiment in conjunction with the accompanying drawings, in which:

FIG. 1 shows a heat-insulating cardboard manufacturing system according to the present invention;

FIG. 2 is a perspective view of a heat-insulating material replacement device according to the invention;

FIG. 3 shows how the heat-insulating material replacement device in FIG. 2 operates;

FIG. 4 is a perspective view of a heat-insulating material mounting mechanism according to the invention; and

FIG. 5 shows the heat-insulating material mounting mechanism in FIG. 4 alongside the heat-insulating material replacement device in FIG. 2.

### DETAILED DESCRIPTION OF THE INVENTION

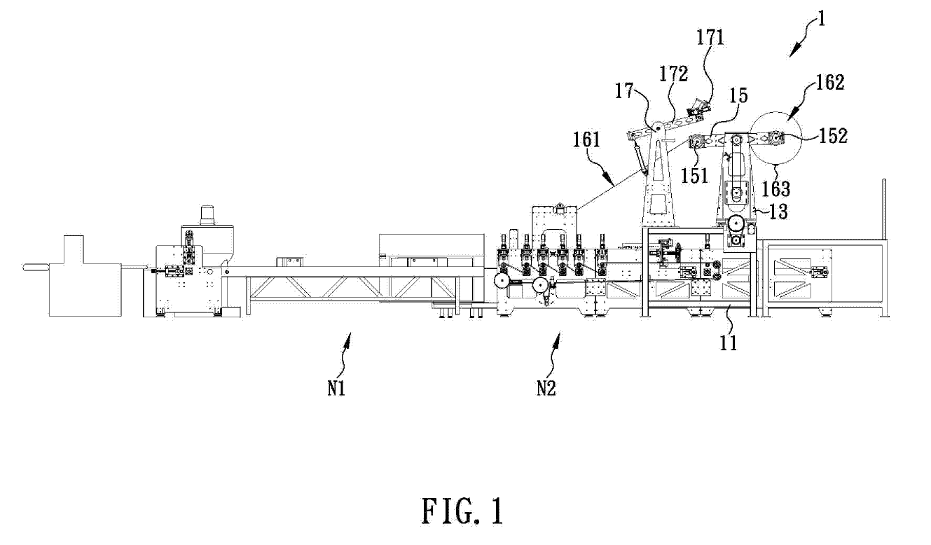

The present invention provides an automatic heat-insulating material replacement device for use in a heat-insulating cardboard manufacturing system. In one embodiment of the invention, referring to FIG. 1, the heat-insulating cardboard manufacturing system at least includes a substrate conveying mechanism N1, a heat-insulating material bonding mechanism N2, and a heat-insulating material replacement device 1. The substrate conveying mechanism N1 is configured to transport a plurality of substrates (e.g., cardboard, wood boards, plastic sheets, or sheets of glass) sequentially into the heat-insulating material bonding mechanism N2 so that each substrate will be coated with a heat-insulating material on one side, with the heat-insulating material fixed (e.g., adhesively bonded) to the substrate. It should be pointed out that the major technical features of the invention consist in the structure and working principle of the “heat-insulating material replacement device 1”. The structural details of the substrate conveying mechanism N1 and of the heat-insulating material bonding mechanism N2, therefore, may be adjusted according to practical needs, provided that the substrate conveying mechanism N1 is capable of “substrate transportation” and the heat-insulating material bonding mechanism N2 is capable of “bonding a substrate and a heat-insulating material together”.

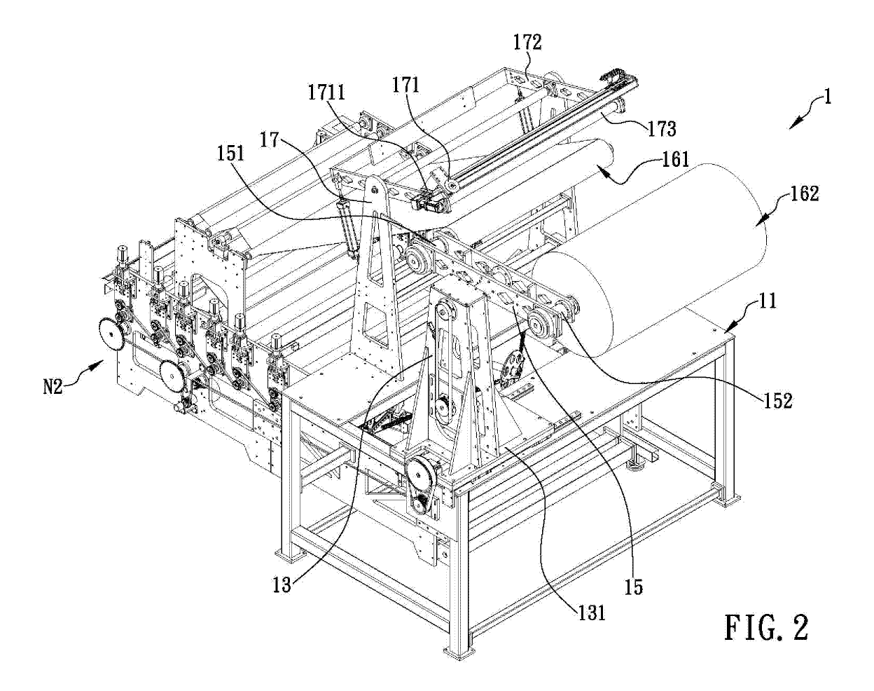

In this embodiment, as shown in FIGS. 1 and 2, the heat-insulating material replacement device 1 at least includes a base 11, a supporting frame 13, a heat-insulating material replacement rack 15, and a vertical stand 17. The supporting frame 13 has a bottom portion mounted on the base 11 and a top portion that extends upward. A middle section of the heat-insulating material replacement rack 15 is pivotally connected to the supporting frame 13 so that the heat-insulating material replacement rack 15 can rotate about an axis defined by the supporting frame 13. For example, in a side view as FIG. 1, the heat-insulating material replacement rack 15 can be rotated clockwise or counterclockwise. In addition, the heat-insulating material replacement rack 15 is pivotally provided with a first reel 151 at one end and a second reel 152 at the opposite end. The first reel 151 is wound with a first heat-insulating material 161, and the second reel 152 is wound with a second heat-insulating material 162. It is worth mentioning that the first heat-insulating material 161 refers to the heat-insulating material in use whereas the second heat-insulating material 162 refers to a spare heat-insulating material. After the heat-insulating material replacing process described further below, the first heat-insulating material 161 is replaced by the second heat-insulating material 162, which becomes the new first heat-insulating material 161, and the original first heat-insulating material 161 is replaced by an unused heat-insulating material, which serves as a spare heat-insulating material (i.e., the new second heat-insulating material 162).

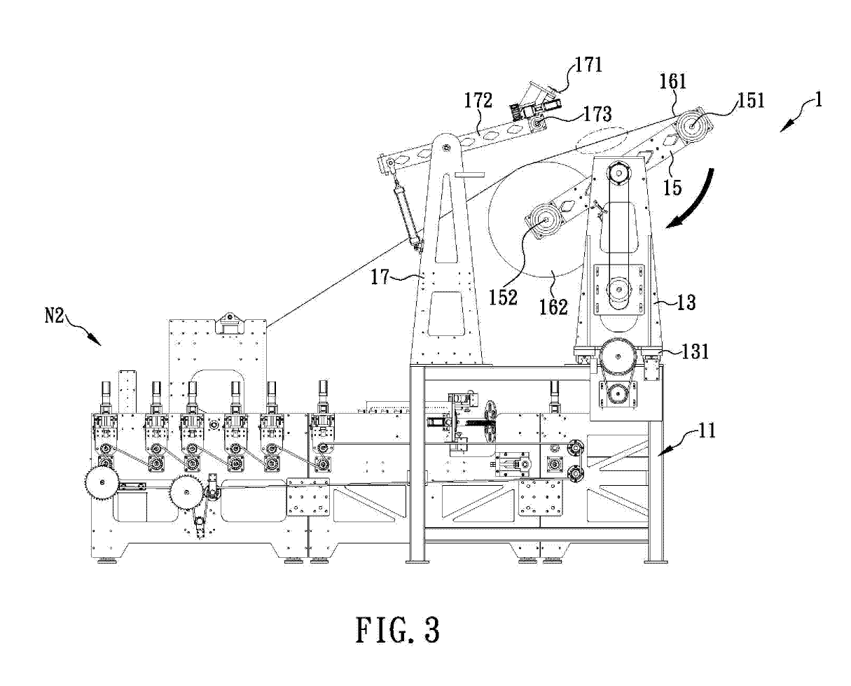

With continued reference to FIGS. 1 and 2, one end (hereinafter referred to as the first end) of the first heat-insulating material 161 is connected to the first reel 151 while the rest of the first heat-insulating material 161 is wound around the first reel 151. The opposite end (hereinafter referred to as the second end) of the first heat-insulating material 161 will be transferred into the heat-insulating material bonding mechanism N2 in order for the first heat-insulating material 161 to coat a substrate. More specifically, the second end of the first heat-insulating material 161 will be fixed on one side of the substrate by hot melt adhesive or other adhesive, and the portion of the first heat-insulating material 161 that trails behind the substrate will be cut off in order to coat the next substrate. The amount of the first heat-insulating material 161 keeps decreasing as the foregoing process continues. As to the second heat-insulating material 162, one end of it is connected to the second reel 152 while the rest of it is wound around the second reel 152. Moreover, an adhesive layer 163 (e.g., double-sided adhesive tape) is provided on an outer surface portion of the second heat-insulating material 162 that is adjacent to the opposite end (hereinafter referred to as the second end) of the second heat-insulating material 162. When the first heat-insulating material 161 is left with a predetermined amount during use, the heat-insulating material replacement rack 15 is rotated in a first direction (e.g., indicated by the clockwise arrow in FIG. 3) such that each of the first reel 151 and the second reel 152 is displaced to a position adjacent to the original position of the other. As a result, the adhesive layer 163 of the second heat-insulating material 162 is adhesively bonded to the surface of the first heat-insulating material 161. When the second end of the first heat-insulating material 161 is subsequently driven by the heat-insulating material bonding mechanism N2, the second end of the second heat-insulating material 162 is transferred to the heat-insulating material bonding mechanism N2 along with the first heat-insulating material 161, allowing the second heat-insulating material 162 to coat a substrate.

In this embodiment, referring to FIGS. 1-3, the vertical stand 17 is fixed to the base 11 at the bottom end and is pivotally provided with a transverse frame 172 adjacent to the top end. The transverse frame 172 is mounted with a cutter 171 and a pressure roller 173 at one end and can rotate about an axis defined by the vertical stand 17 (e.g., clockwise or counterclockwise). The cutter 171 and the pressure roller 173 can be brought close to the first reel 151, with the pressure roller 173 at a lower position than the cutter 171. Once the adhesive layer 163 of the second heat-insulating material 162 is adhesively bonded to the surface of the first heat-insulating material 161, the transverse frame 172 is rotated such that the aforesaid end thereof is displaced toward the first heat-insulating material 161. The pressure roller 173 will be pressed against the area where the second heat-insulating material 162 is adhesively bonded to the first heat-insulating material 161, ensuring a tight adhesive bond between the first heat-insulating material 161 and the second heat-insulating material 162, for if the bond is not secure enough, the second heat-insulating material 162 may separate from the first heat-insulating material 161 while being driven by the first heat-insulating material 161.

With continued reference to FIGS. 1-3, the cutter 171 is fixed on a slider 1711, and the slider 1711 is reciprocatingly movably mounted on the transverse frame 172. In this embodiment, the slider 1711 can be slid on the transverse frame 172 in a direction corresponding to the transverse direction of the first heat-insulating material 161 (e.g., from the lower left corner of FIG. 2 to the upper right corner). Once the pressure roller 173 is pressed against the adhesively bonded area of the first and the second heat-insulating materials 161, 162, the cutter 171 is displaced toward the first heat-insulating material 161, and as soon as the cutter 171 is pressed against the first heat-insulating material 161, the slider 1711 drives the cutter 171 to sever the first heat-insulating material 161 transversely, the severing position lying between the first end of the first heat-insulating material 161 and the adhesively bonded area of the first and the second heat-insulating materials 161, 162 (i.e., the dashed-line circled area in FIG. 3). Consequently, the second heat-insulating material 162 begins to work in place of the first heat-insulating material 161. An operator can now replace the remaining first heat-insulating material 161 on the first reel 151 with a new heat-insulating material. When the second heat-insulating material 162 is left with the predetermined amount during use, the heat-insulating material replacement rack 15 will be rotated again, and the process described above, repeated.

With continued reference to FIGS. 1-3, the heat-insulating material replacing process of the present invention is different from its prior art counterparts in that an operator only has to operate the heat-insulating material replacement rack 15 and the cutter 171 when the first heat-insulating material 161 is about to be used up, and the second heat-insulating material 162 will replace the first heat-insulating material 161 rapidly. Once the second heat-insulating material 162 starts to be transferred to the heat-insulating material bonding mechanism N2, the operator can replace the remaining first heat-insulating material 161 on the first reel 151 with a new one. In the aforesaid process, the heat-insulating cardboard manufacturing system needs to be shut down for only about 8-10 seconds in order to complete “bonding the heat-insulating materials 161, 162 adhesively” and “severing the first heat-insulating material 161”. When a new heat-insulating material is subsequently mounted, system operation is already resumed with the second heat-insulating material 162; thus, the heat-insulating material replacement device 1 helps increase the productivity of the heat-insulating cardboard manufacturing system significantly. In other embodiments of the present invention, the connection between and the structures of the vertical stand 17 and cutter 171 may be adjusted as appropriate. For example, the height of the vertical stand 17 may be increased, with the cutter 171 provided in a middle section of the vertical stand 17, or the vertical stand 17 may be fixed directly on the ground, provided that the cutter 171 is mounted on the vertical stand 17, is adjacent to the first reel 151, and can sever the first heat-insulating material 161.

Besides, the first heat-insulating material 161 may extend obliquely due to the fact that it is constantly stretched while being conveyed. Should that happen, the first heat-insulating material 161 cannot coat a substrate effectively, meaning a portion of the substrate may not be coated with the first heat-insulating material 161, and a high defective percentage follows. In consideration of this, referring back to FIG. 2, the bottom portion of the supporting frame 13 is provided with a correcting base 131. The correcting base 131 is mounted on the base 11 and can drive the supporting frame 13 to slide on the base 11 (e.g., in a direction from the lower left corner of FIG. 2 to the upper right corner), thereby providing the supporting frame 13 with a “shaking” effect, enabling the supporting frame 13 to adjust the position of the first heat-insulating material 161 after the first heat-insulating material 161 is transported to the heat-insulating material bonding mechanism N2. This ensures that the first heat-insulating material 161 corresponds in position to a substrate and can coat the substrate effectively.

It should be pointed out that, referring back to FIGS. 1-3, the subject matter for which patent protection is sought by the applicant is the structure of the heat-insulating material replacement device 1. In practice, whether the first heat-insulating material 161 is about to be used up can be determined through visual observation or by means of a sensor that monitors the consumption of the first heat-insulating material 161. By the same token, the heat-insulating material replacement rack 15, the slider 1711, and the correcting base 131 may be operated manually (e.g., by pressing the corresponding start buttons respectively) or started automatically by the corresponding sensors respectively. In other words, a person skilled in the art who has fully understood the technical features of the present invention may render some of the aforesaid components fully automatic or semi-automatic according to operation requirements without departing from the scope of the invention.

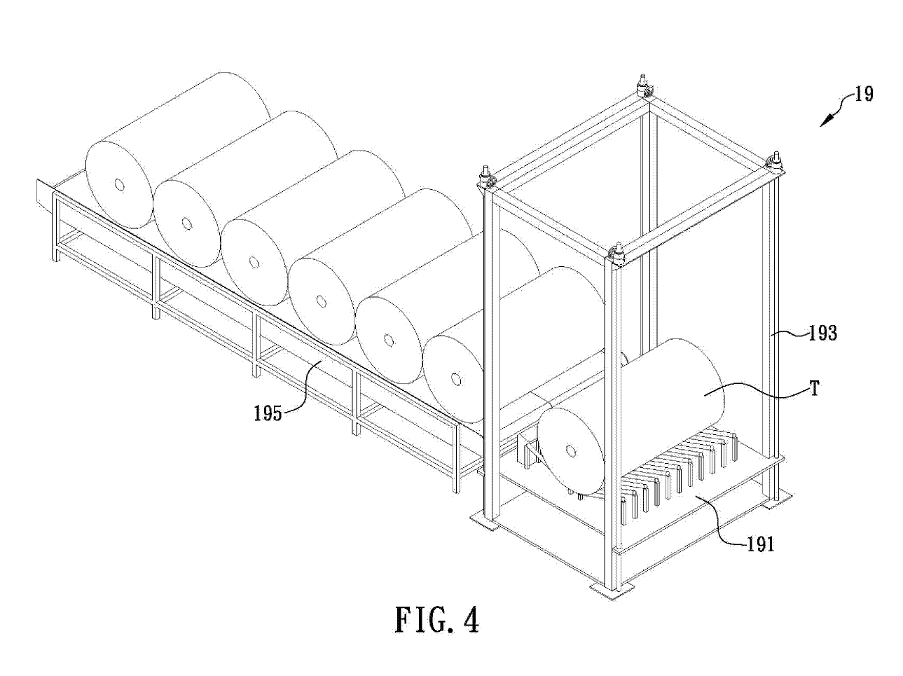

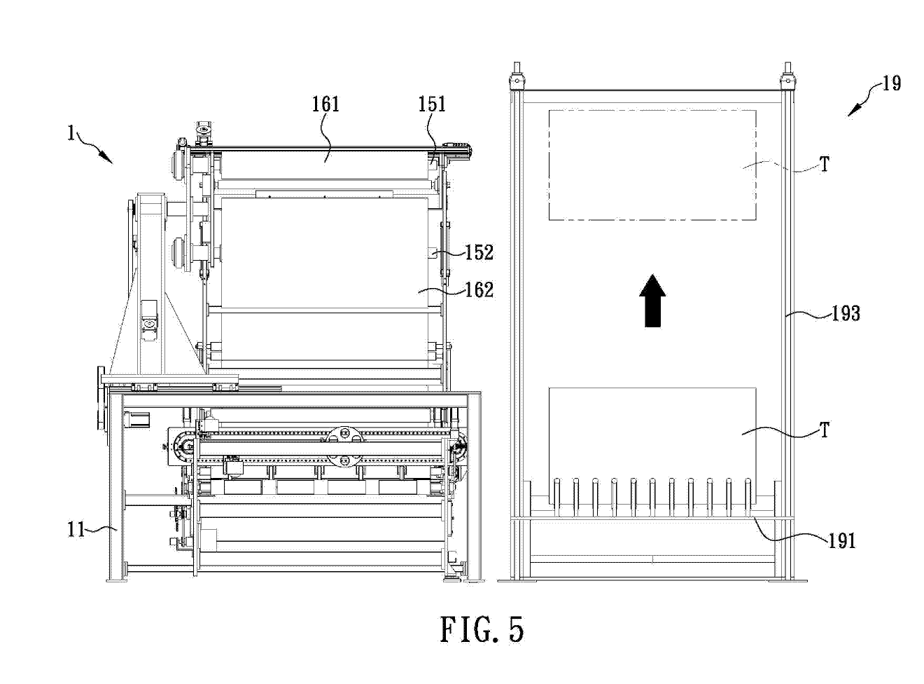

To enhance the efficiency at which an operator can replace the remaining first heat-insulating material 161 on the first reel 151 with a new heat-insulating material, referring to FIGS. 4 and 5, the heat-insulating material replacement device 1 further includes a heat-insulating material mounting mechanism 19 adjacent to the base 11. The heat-insulating material mounting mechanism 19 is composed at least of a lifting platform 191 and a lifting frame 193, wherein the lifting platform 191 is configured to be displaced vertically along the axial direction of the lifting frame 193. An operator can put a new heat-insulating material (i.e., a spare heat-insulating material T) on the lifting platform 191 when the lifting platform 191 is adjacent to a lower portion of the lifting frame 193. Once the second heat-insulating material 162 has replaced the first heat-insulating material 161, as shown in FIG. 3, the lifting platform 191 is displaced upward until the spare heat-insulating material T corresponds in position to the first heat-insulating material 161 (as shown in FIG. 5 by the dashed-line rectangle), allowing the operator to remove the first heat-insulating material 161 and, after applying adhesive or double-sided adhesive tape to the spare heat-insulating material T to form the adhesive layer 163, mount the spare heat-insulating material T fixedly on the first reel 151 (e.g., by means of an air lock), in order for the spare heat-insulating material T to function as a new second heat-insulating material 162. Thus, the heat-insulating material mounting mechanism 19 helps increase the efficiency and ease of heat-insulating material replacement.

In addition, referring again to FIGS. 4 and 5, the heat-insulating material mounting mechanism 19 includes a heat-insulating material conveyer belt 195 on which a plurality of heat-insulating materials can be placed. One end of the heat-insulating material conveyor belt 195 is adjacent to the lifting frame 193. When the lifting platform 191 is adjacent to the lower portion of the lifting frame 193, the heat-insulating material conveyor belt 195 can convey one of the heat-insulating materials thereon to the lifting platform 191 either automatically or manually so that the heat-insulating material conveyed to the lifting platform 191 serves as the spare heat-insulating material T.

The foregoing is only a couple of embodiments of the present invention. A person skilled in the art may modify or change the disclosed embodiments in many ways according to the disclosure of the present specification without departing from the scope of the invention.

What is claimed is:

1. An automatic heat-insulating material replacement device for use in a heat-insulating cardboard manufacturing system, wherein the heat-insulating cardboard manufacturing system comprises a substrate conveying mechanism, a heat-insulating material bonding mechanism, and the heat-insulating material replacement device, and the substrate conveying mechanism transports a substrate into the heat-insulating material bonding mechanism in order for a side of the substrate to be coated with a heat-insulating material, the heat-insulating material replacement device being characterized by comprising:
a base;
a supporting frame having a bottom portion mounted on the base;
a heat-insulating material replacement rack having a middle section pivotally connected to the supporting frame in order for the heat-insulating material replacement rack to rotate about an axis defined by the supporting frame, the heat-insulating material replacement rack further having an end pivotally provided with a first reel and another end pivotally provided with a second reel, wherein a first heat-insulating material has a first end connected to the first reel, is wound around the first reel, and has an opposite end to be transferred to the heat-insulating material bonding mechanism in order for the substrate to be coated with the first heat-insulating material; and a second heat-insulating material has an end connected to the second reel, is wound around the second reel, and has an outer surface portion adjacent to an opposite second end of the second heat-insulating material and provided with an adhesive layer; and
a vertical stand provided with a cutter adjacent to the first reel;
the heat-insulating material replacement device being further characterized in that:
when the first heat-insulating material is left with a predetermined amount during use, the heat-insulating material replacement rack is rotated in a first direction to displace each of the first reel and the second reel to a position adjacent to an original position of the other of the first reel and the second reel and to bond the adhesive layer of the second heat-insulating material to a surface of the first heat-insulating material so that the second end of the second heat-insulating material is transferrable to the heat-insulating material bonding mechanism along with the first heat-insulating material, allowing the second heat-insulating material to coat the substrate, and the cutter is displaced toward the first heat-insulating material to sever the first heat-insulating material at a position between the first end of the first heat-insulating material and an area where the heat-insulating materials are adhesively bonded together.

2. The automatic heat-insulating material replacement device of claim 1, wherein the vertical stand is further provided with a pressure roller, and when the cutter is displaced toward the first heat-insulating material and has yet to sever the first heat-insulating material, the pressure roller is pressed against the area where the heat-insulating materials are adhesively bonded together, in order to ensure a tight adhesive bond between the heat-insulating materials.

3. The automatic heat-insulating material replacement device of claim 2, wherein the vertical stand is pivotally provided with a transverse frame, and the transverse frame has an end mounted with the cutter and the pressure roller and is rotatable about an axis defined by the vertical stand in order to displace the cutter and the pressure roller toward the first heat-insulating material.

4. The automatic heat-insulating material replacement device of claim 3, wherein the cutter is fixed on a slider, and the slider is mounted on the transverse frame and is slidable on the transverse frame in a direction corresponding to a transverse direction of the first heat-insulating material in order for the cutter to sever the first heat-insulating material along the transverse direction.

5. The automatic heat-insulating material replacement device of claim 4, wherein the vertical stand has a bottom end fixed to the base and is pivotally provided with the transverse frame at a position adjacent to a top end of the vertical stand.

6. The automatic heat-insulating material replacement device of claim 1, wherein the bottom portion of the supporting frame is provided with a correcting base, and the correcting base is mounted on the base and is configured to drive the supporting frame to slide on the base so that, once transferred to the heat-insulating material bonding mechanism, the first heat-insulating material is made to correspond in position to the substrate in order to coat the substrate.

7. The automatic heat-insulating material replacement device of claim 2, wherein the bottom portion of the supporting frame is provided with a correcting base, and the correcting base is mounted on the base and is configured to drive the supporting frame to slide on the base so that, once transferred to the heat-insulating material bonding mechanism, the first heat-insulating material is made to correspond in position to the substrate in order to coat the substrate.

8. The automatic heat-insulating material replacement device of claim 3, wherein the bottom portion of the supporting frame is provided with a correcting base, and the correcting base is mounted on the base and is configured to drive the supporting frame to slide on the base so that, once transferred to the heat-insulating material bonding mechanism, the first heat-insulating material is made to correspond in position to the substrate in order to coat the substrate.

9. The automatic heat-insulating material replacement device of claim 4, wherein the bottom portion of the supporting frame is provided with a correcting base, and the correcting base is mounted on the base and is configured to drive the supporting frame to slide on the base so that, once transferred to the heat-insulating material bonding mechanism, the first heat-insulating material is made to correspond in position to the substrate in order to coat the substrate.

10. The automatic heat-insulating material replacement device of claim 5, wherein the bottom portion of the supporting frame is provided with a correcting base, and the correcting base is mounted on the base and is configured to drive the supporting frame to slide on the base so that, once transferred to the heat-insulating material bonding mechanism, the first heat-insulating material is made to correspond in position to the substrate in order to coat the substrate.

11. The automatic heat-insulating material replacement device of claim 6, further comprising a heat-insulating material mounting mechanism adjacent to the base, wherein the heat-insulating material mounting mechanism is composed at least of a lifting platform and a lifting frame, and the lifting platform allows a spare heat-insulating material to be placed thereon and is vertically displaceable in an axial direction of the lifting frame so that, once the second heat-insulating material has replaced the first heat-insulating material, the lifting platform is displaceable upward to make the spare heat-insulating material correspond in position to the first heat-insulating material.

12. The automatic heat-insulating material replacement device of claim 7, further comprising a heat-insulating material mounting mechanism adjacent to the base, wherein the heat-insulating material mounting mechanism is composed at least of a lifting platform and a lifting frame, and the lifting platform allows a spare heat-insulating material to be placed thereon and is vertically displaceable in an axial direction of the lifting frame so that, once the second heat-insulating material has replaced the first heat-insulating material, the lifting platform is displaceable upward to make the spare heat-insulating material correspond in position to the first heat-insulating material.

13. The automatic heat-insulating material replacement device of claim 8, further comprising a heat-insulating material mounting mechanism adjacent to the base, wherein the heat-insulating material mounting mechanism is composed at least of a lifting platform and a lifting frame, and the lifting platform allows a spare heat-insulating material to be placed thereon and is vertically displaceable in an axial direction of the lifting frame so that, once the second heat-insulating material has replaced the first heat-insulating material, the lifting platform is displaceable upward to make the spare heat-insulating material correspond in position to the first heat-insulating material.

14. The automatic heat-insulating material replacement device of claim 9, further comprising a heat-insulating material mounting mechanism adjacent to the base, wherein the heat-insulating material mounting mechanism is composed at least of a lifting platform and a lifting frame, and the lifting platform allows a spare heat-insulating material to be placed thereon and is vertically displaceable in an axial direction of the lifting frame so that, once the second heat-insulating material has replaced the first heat-insulating material, the lifting platform is displaceable upward to make the spare heat-insulating material correspond in position to the first heat-insulating material.

15. The automatic heat-insulating material replacement device of claim 10, further comprising a heat-insulating material mounting mechanism adjacent to the base, wherein the heat-insulating material mounting mechanism is composed at least of a lifting platform and a lifting frame, and the lifting platform allows a spare heat-insulating material to be placed thereon and is vertically displaceable in an axial direction of the lifting frame so that, once the second heat-insulating material has replaced the first heat-insulating material, the lifting platform is displaceable upward to make the spare heat-insulating material correspond in position to the first heat-insulating material.

16. The automatic heat-insulating material replacement device of claim 11, wherein the heat-insulating material mounting mechanism further comprises a heat-insulating material conveyor belt on which a plurality of heat-insulating materials are placeable, the heat-insulating material conveyer belt has an end adjacent to the lifting frame, and when the lifting platform is adjacent to a lower portion of the lifting frame, the heat-insulating material conveyor belt is able to convey one of the heat-insulating materials placed thereon to the lifting platform either automatically or manually as the spare heat-insulating material.

17. The automatic heat-insulating material replacement device of claim 12, wherein the heat-insulating material mounting mechanism further comprises a heat-insulating material conveyor belt on which a plurality of heat-insulating materials are placeable, the heat-insulating material conveyer belt has an end adjacent to the lifting frame, and when the lifting platform is adjacent to a lower portion of the lifting frame, the heat-insulating material conveyor belt is able to convey one of the heat-insulating materials placed thereon to the lifting platform either automatically or manually as the spare heat-insulating material.

18. The automatic heat-insulating material replacement device of claim 13, wherein the heat-insulating material mounting mechanism further comprises a heat-insulating material conveyor belt on which a plurality of heat-insulating materials are placeable, the heat-insulating material conveyer belt has an end adjacent to the lifting frame, and when the lifting platform is adjacent to a lower portion of the lifting frame, the heat-insulating material conveyor belt is able to convey one of the heat-insulating materials placed thereon to the lifting platform either automatically or manually as the spare heat-insulating material.

19. The automatic heat-insulating material replacement device of claim 14, wherein the heat-insulating material mounting mechanism further comprises a heat-insulating material conveyor belt on which a plurality of heat-insulating materials are placeable, the heat-insulating material conveyer belt has an end adjacent to the lifting frame, and when the lifting platform is adjacent to a lower portion of the lifting frame, the heat-insulating material conveyor belt is able to convey one of the heat-insulating materials placed thereon to the lifting platform either automatically or manually as the spare heat-insulating material.

20. The automatic heat-insulating material replacement device of claim 15, wherein the heat-insulating material mounting mechanism further comprises a heat-insulating material conveyor belt on which a plurality of heat-insulating materials are placeable, the heat-insulating material conveyer belt has an end adjacent to the lifting frame, and when the lifting platform is adjacent to a lower portion of the lifting frame, the heat-insulating material conveyor belt is able to convey one of the heat-insulating materials placed thereon to the lifting platform either automatically or manually as the spare heat-insulating material.
